(19) United States
(12) Patent Application Publication
(10) Pub. No.: US 2018/0343987 A1
(43) Pub. Date: Dec. 6, 2018

(54) FOLDING CLASP

(71) Applicant: BIOWATCH SA, Lausanne, OT (CH)

(72) Inventor: Pascal QUELOZ, La Chaux-de-Fonds (CH)

(73) Assignee: BIOWATCH SA, Lausanne, OT (CH)

(21) Appl. No.: 15/778,978

(22) PCT Filed: Nov. 22, 2016
(86) PCT No.: PCT/IB2016/057026

§ 371 Date: May 24, 2018

(30) Foreign Application Priority Data
Nov. 25, 2015 (CH) 01717/15

(51) Int. Cl. A44C 5/24; A44C 5/14

(52) U.S. Cl. CPC A44C 5/24; G04B 37/1486; A44C 5/147

(57) ABSTRACT

The invention relates to a folding clasp for a bracelet, comprising a buckle that can be opened up and is provided with a main unfolding strip surrounded by two pivoting fastening shafts (with hinges), characterized in that said main unfolding strip has a frame, the inner profile of which defines an opening for removably housing a removable insert.

### TECHNICAL FIELD OF THE INVENTION

The present invention relates to a fastener with a folding clasp for a bracelet, in particular for a watch strap. The invention also provides for a group of components for a bracelet having a fastener with a folding clasp and an insert. The invention may be used in the field of watchmaking, especially for wristwatches, but also for other uses, for example for belts.

### STATE OF THE ART

Many bracelet closure devices are known today. Conventionally, such fasteners comprise a folding clasp. These devices comprise a set of blades assembled together by means of hinges. These devices are generally designed to be able to adopt an extended form or position, in which the blades allow the bracelet to have a longer length, and a closed form or position, with at least a portion of the plane of the blades being substantially superimposed, allowing the bracelet to have a shorter length, corresponding to a configuration in which the bracelet is attached to the wrist of the user.

Several types of fasteners are also known which comprise specific elements, generally fixed, and intended for functions related to those of the bracelet itself. For example, document CH705058, describes a bracelet clasp for fine adjustment of the length of the bracelet. For this purpose, the clasp comprises a rack provided with several notches with a tooth, engageable in one of the notches, so as to determine the length of the bracelet. The clasp includes a magnet or an elastic member, to hold the inserted tooth in one of the notches.

It is worth noting that this type of device optimizes functions or features inherent to the bracelet, such as comfort, ease of putting on or taking off, etc.

Watch bracelets specifically designed to house or integrate electronic elements such as RFID or other elements are also known.

For example, the document EP1240619 describes an electronic tag for a watch strap, provided with an antenna integrated in a rigid zone of the bracelet. The bracelet is configured specifically to allow the integration of the tag and especially that of the antenna.

WO2007011514 discloses an RFID bracelet comprising a lower layer on which are positioned an antenna and an RFID element, the whole assembly being covered by a main layer of the bracelet. The embodiment is specifically provided to integrate in the bracelet both the antenna and the RFID element.

These latter devices make it possible to perform functions other than those inherent to the bracelet, but require specific complex, expensive implementations, offering little flexibility to provide other functions than originally planned.

There is therefore a need for a solution to implement functions distinct from or complementary to those directly related to the bracelet, without requiring a total redesign of the bracelet, or that the bracelet be specifically and permanently dedicated to this type of configuration.

### BRIEF DESCRIPTION OF THE INVENTION

Firstly, a first object of the invention is to provide a bracelet closure device, in particular for a watch strap, for attaching an insert without affecting the overall size and without hindering the comfort of the user.

Another object of the invention is to provide a bracelet closure device, in particular for a watch strap, allowing for an insert to be removably attached.

Yet another object of the invention is to provide a bracelet closure device, in particular for a watch strap, allowing for an insert to be attached without affecting the aesthetics of the bracelet.

To do this, the invention provides a fastener for a bracelet comprising a folding clasp provided with a main folding blade surrounded by two pivoting attachment pins (with hinges), said main folding blade having a frame whose internal profile delimits an opening having a shape adapted to house, preferably removably, an insert.

Such a fastening arrangement allows a simple and effective integration of a complementary element, without affecting the aesthetics of the fastener and/or bracelet. The insert is advantageously removable, to allow either to replace it with another type of insert, or to allow it to be removed for example to perform an update of the parameters of the insert. The integration in the clasp is highly discreet while maintaining the level of comfort for the user.

Advantageously, the opening comprises at least two lateral notches adapted to accommodate corresponding stops provided on the outer profile of the insert. Such notches, in conjunction with the corresponding stops of the insert, allow easy placement and good positioning. By adjusting the notches and/or the abutments, the position of the insert can be adapted according to the functional or aesthetic needs.

The opening of the frame is preferably of substantially oblong shape. This shape allows the integration of a multitude of types of inserts, easy to achieve, with a high quality appearance and presentation. According to other variants, other shapes, more or less elongated and/or more or less rounded, are provided.

The invention furthermore provides a bracelet assembly, in particular for a watchstrap, comprising on the one hand: a fastener comprising a folding clasp provided with a main folding blade surrounded by two pivoting attachment shafts (with hinges), said main folding blade comprising a frame whose internal profile delimits an opening shaped to accommodate, preferably removably, an insert; and on the other hand: an insert comprising a lateral external profile substantially adapted for insertion of said insert into said opening of the frame.

Such an assembly allows for the realization of a wide range of combinations of clasps and inserts, in a simple, economical, ergonomic manner, while maintaining the aesthetics of the fastener.

Advantageously, the frame comprises, on its internal profile, at least two notches, adapted to accommodate the fixing stops of the insert.

The main folding blade has preferably a flared U-shape, the insert being insertable through the opening of said U, that is to say from below the clasp, wrist side. This contoured shape makes it possible to respect the curvatures of the wrist of the user, for a great comfort, while facilitating the installation and/or removal of the inserts.

According to an advantageous embodiment, the insert comprises at least two fixing stops arranged on the lateral profile of the insert.

Depending on which embodiment, the insert is an electronic element or a sensor, in particular a biometric sensor, or an accelerometer, or a vibrator.

According to an advantageous embodiment, the insert is adapted to exchange data with an external device (such as a computer, a tablet, a smartphone or the like).

According to an advantageous embodiment, the long and short folding blades are provided with closure contacts capable of cooperating with a closure detector of the insert.

According to another advantageous embodiment, the frame is provided with a control button adapted to cooperate with an interface pad of the insert.

The invention also provides a folding clasp fastener for an assembly for a bracelet as previously described.

The invention furthermore provides an insert for a bracelet assembly as previously described.

Finally, the invention also provides a watch strap comprising a fastening strap as previously described.

### BRIEF DESCRIPTION OF THE DRAWINGS

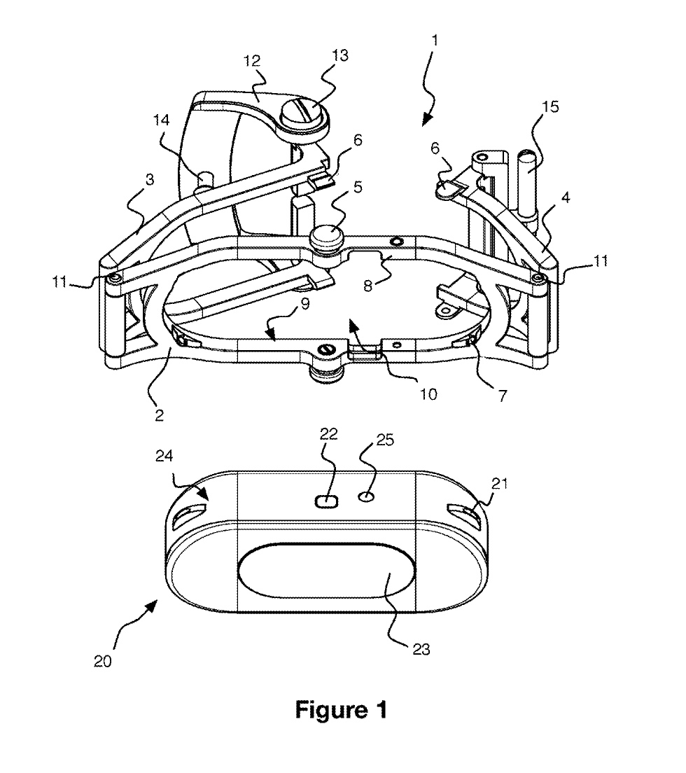

All the details relative to the conception of embodiments are given in the following description, supplemented by the single drawing, presented solely for the purpose of providing non-limiting examples, and in which: FIG. 1 presents a perspective view of an exemplary embodiment of a folding clasp according to the invention, before introduction of an insert.

### DETAILED DESCRIPTION OF THE INVENTION

FIG. 1 illustrates a clasp according to an embodiment of the invention. As illustrated, the clasp comprises a substantially elongated and arched main blade 2, forming a substantially flared inverted U. On a first side of the main blade 2, a long folding blade 3 is connected to the main blade 2 by a hinge 11. Similarly, on the other side of the main blade 2, a short folding blade 4 is connected to the main blade 2, also by a hinge 11. The respective lengths of the folding blades 3 and 4 may vary according to the embodiments and the dimensions of the clasp. The blades of the clasp are arranged to move between a closed position and an open position. In the first of these positions, at least one of the blades other than the main folding blade is superimposed at least partially against the main folding blade. This mode allows the closing of the bracelet substantially adjusted on the wrist of the user. In the open position, the blades are pivoted and deployed to enlarge the circumference of the bracelet.

In the case where the clasp is used with a wristwatch with a flexible bracelet such as a leather strap, on one side of the clasp, the shank 15 allows attachment to the wristband of the watch. On the other side, the fastening finger 14 can be inserted into one of the holes of the bracelet.

In the exemplary embodiment illustrated, a clasp push-button 13 provided on the long folding blade 3 at the interface with the cover 12 makes it possible to unlock the folding clasp to switch from the closed mode to the deployed mode.

In the illustrated embodiment, the long 3 and short folding blades 4 are provided with closure contacts 6 adapted to cooperate with a loop closure detector 25 provided on the insert. In the illustrated example, the closure detector 25 is disposed on the outer profile of the insert. When the long 3 and short 4 folding blades are in the closed position, the contacts 6 of these blades cooperate with the detector 25, indicating the closed position of the folding clasp. The insert 20 receives the corresponding pulse, and thus has data for implementing (or not) certain functions, according to the embodiments and the context of use.

Also as shown in FIG. 1, the main folding blade 2 comprises a frame 8 whose inner profile 9 defines an opening 10 in which an insert 20 can be housed, preferably removably. Locking elements 7, for example fixing notches 7, are provided in the internal profile 9 of the frame. These notches 7 allow to properly position the insert 20 and to lock it in place by means of corresponding elements, for example fixing stops 21 provided on the outer profile 24 of the insert 20. The stops 21 cooperate with the notches 7 to hold the insert 20 fixed to the frame. To ensure that the insert is held in place, the notches 7 and/or the stops 21 may be provided with fastening means such as ball pawls, spring balls, magnets, or the like. The insert can be fixed by forcing the stops into the notches, and detached from the frame by pushing it from above. When the clasp is worn and resting against the wrist, the insert cannot be removed.

The position of the bearing abutments 21 and notches 7 is provided to allow adjustment of the distance between the inner face of the insert and the skin of the user in the fastener's closed mode, for optimal operation of the sensor. Depending on the dimensions and shapes of the insert 20 and the frame 8, the assembly for the strap may be configured such that the bottom plane of the mounted insert is substantially aligned with the base of the frame, or that the bottom plane of the insert extends under the frame.

In the example illustrated, the internal profile 9 of the frame 8 and the external profile 24 of the insert 20 are of substantially oblong corresponding shapes with respective dimensions allowing easy insertion and removal of the insert 20 into the opening 10.

A control button 5, provided on the frame 8, is arranged to collaborate with a portion 22 of the insert 20, for example with an interface pad 22. This control button 5 is actuated to implement one or more functions of the insert by acting on the pad, for example in order to start a biometric reading or a measurement with a sensor, or a data transmission. It is possible to provide a control button on each side of the frame, to trigger two separate functions of the insert. A return spring (not shown in the drawing) makes it possible to push each pusher towards the outside.

The insert 20 is preferably an electronic module, a sensor, or a vibrating element. A user interface 23 is preferably provided on the user side. According to an advantageous embodiment, the insert 20 is a biometric sensor. In this case, the user interface 23 is a biometric interface, provided under the insert, so as to be in the immediate vicinity of the user's skin when the bracelet is in place and the clasp in the closed position. This biometric interface allows the biometric sensor to implement its specific functions, such as functions for recognition tissue or of areas of the skin.

The insert preferably comprises a connector (not shown), such as for example a USB connector or the like, to facilitate linking with an external element such as a computer or a tablet, for example to perform an update or a customization of the parameters and/or to perform an electrical recharge. Thanks to the clasp of the invention, an insert can be quickly and easily removed from its inserted position in the clasp to allow to perform such a connection with an external device. Once the update is completed, the insert is put back in place in the clasp.

It goes without saying that the present invention is not limited to the embodiments which have just been described and that various different embodiments may be envisaged by the skilled person without departing from the scope of the present invention. For example, by modifying the dimensions of the frame 8 and/or its internal profile 9, it is possible to design a bracelet assembly whose dimensions and shapes may differ from the exemplary embodiment illustrated.

### REFERENCE NUMBER USED IN THE DRAWINGS

1 Folding clasp
2 Main Folding Blade
3 Long Folding Blade
4 Short Folding Blade
5 Control Button
6 Closure Contacts of the Folding Clasp
7 Locking elements, e.g. Fixing Notches
8 Frame
9 Internal Profile of the Frame
10 Opening
11 Hinges
12 Cover
13 Clasp Pushbutton
14 Attachment Finger
15 Wriststrap
20 Removable Insert
21 Fixing Stops
22 Interface Pad
23 User Interface
24 Lateral profile of the Insert
25 Closure Detector

1. A fastener for a bracelet, the fastener comprising a folding clasp, the folding clasp comprising:
a main folding blade; and
two pivoting attachment pins surrounding said main folding blade;
wherein said main folding blade comprises a frame whose internal profile delimits an opening shaped to accommodate and removably retain an insert.

2. The fastener according to claim 1, wherein the opening comprises at least two locking elements arranged to cooperate with corresponding elements on the outer profile of the insert.

3. The fastener according to claim 2, the locking elements being constituted by lateral notches adapted to accommodate corresponding stops provided on the outer profile of the insert.

4. The fastener according to claim 3, the locking elements comprising ball pawls, spring balls or magnets.

5. The fastener according to claim 1, wherein the opening of the frame has a substantially oblong shape.

6. An assembly for a strap comprising:
a fastener comprising a folding clasp provided with a main folding blade surrounded by two pivoting attachment pins, said main folding blade comprising a frame whose internal profile defines an opening of a shape adapted to removably receive and retain an insert; and
an insert having a lateral outer profile cooperating with said opening of the frame in order to retain the insert.

7. The assembly according to claim 6, wherein the frame comprises, on its inner profile, at least two locking elements cooperating with corresponding elements on the outer profile of the insert.

8. The assembly according to claim 6, wherein the main folding blade is of a flared U-shape, the insert being insertable through the opening of said U shape under the lower face of the fastener.

9. The assembly according to claim 6, wherein the insert comprises at least two attachment stops arranged on the lateral profile of the insert.

10. The assembly according to claim 6, wherein the insert (20) is a sensor, or an accelerometer, or a vibrator.

11. The assembly according to claim 6, wherein the insert is adapted to exchange data with an external device.

12. The assembly according to claim 6, wherein the long and short folding blades are provided with at least one closure contact adapted to cooperate with a closure detector of the insert to detect in the insert a closed position of the fastener.

13. The assembly according to claim 6, wherein the frame is provided with a control button adapted to cooperate with a portion of the insert to control a function of the insert by acting on the button.

14. A removeable insert for the bracelet assembly according to claim 6, comprising a sensor or an accelerometer, or a vibrator, and at least two locking elements on the lateral profile of the insert to removably fix the insert in a clasp.

15. The assembly of claim 6, wherein the strap is a watch strap.

16. The assembly of claim 10, wherein the insert is a biometric sensor.

17. The assembly of claim 14, wherein the sensor is a biometric sensor.
